(19) United States
(12) Patent Application Publication
(10) Pub. No.: US 2026/0187736 A1
(43) Pub. Date: Jul. 2, 2026

(54) SYSTEMS AND METHODS FOR USING MACHINE LEARNING TO PREDICT CRITICAL CONSTRAINTS

(71) Applicant: FLUENCE ENERGY, LLC, Arlington, VA (US)

(72) Inventors: Ali DARAEEPOUR, Arlington, VA (US); Mary Elaine CUNHA, Arlington, VA (US); William WeiKang TSO, Arlington, VA (US)

(73) Assignee: FLUENCE ENERGY, LLC, Arlington, VA (US)

(21) Appl. No.: 18/834,433

(22) PCT Filed: Mar. 1, 2024
(86) PCT No.: PCT/US2024/018027

§ 371 Date: Jul. 30, 2024

Related U.S. Application Data
(60) Provisional application No. 63/487,942, filed on Mar. 2, 2023.

(51) Int. Cl. G06Q 50/06; G06N 20/00; G06Q 10/0631

(52) U.S. Cl. CPC G06Q 50/06; G06N 20/00; G06Q 10/06314

(57) ABSTRACT

A computer-implemented method and computer program product for predicting a required committed capacity of an electric utility are provided. The method includes the steps of: (a) performing a stochastic optimization of raw data to produce a total committed capacity from conventional thermal units as a target data, wherein the raw data comprises grid operating conditions; (b) combining the total committed capacity from conventional thermal units with raw features and engineered features to generate training data; (c) training a machine learning model for predicting the required committed capacity of the electric utility using the generated training data; (d) predicting the required committed capacity of the electric utility using the trained machine learning model; and (e) running an augmented version of a deterministic dispatch optimization model based on the predicted required committed capacity of the electric utility. The computer program performs the aforementioned steps.

### CROSS-REFERENCE TO RELATED APPLICATIONS

This application claims priority to U.S. Patent Application No. 63/487,942 filed on Mar. 2, 2023, titled “Systems and Methods for Using Machine Learning to Predict Critical Constraints,” the entirety of which is hereby incorporated by reference herein.

### TECHNICAL FIELD

The present disclosure relates to power generation in an electric utility, and particularly to predicting the required committed capacity of an electric utility.

### BACKGROUND

Vertically integrated utilities (“VIUs”) create their day-ahead (“DA”) unit commitment and generation dispatch schedules based on forecasts for future load demand, resource availability, fuel prices, etc. These schedules include the on/off statuses and power outputs of generators, as well as the charging/discharging patterns of energy storage assets. Scheduling ahead of time allows slow-start generators (e.g., steam turbine or combine-cycle plants) to have enough notice in advance so that they can follow their planned operations since their commitment (on/off) status cannot be adjusted later in real-time at short notice. However, the optimality of these day-ahead commitment and dispatch schedules depends on how well they consider the uncertainty of future grid conditions versus what actually happens later in real-time.

In particular, day-ahead forecasts for variable renewable energy (“VRE”), such as solar and wind, for example, are often inaccurate, and their real-time generation may significantly deviate from the forecasted values. Due to these VRE deviations, the net load (demand-VRE generation) that the other non-VRE resources must satisfy will fluctuate as well. The net load uncertainty that arises in real-time makes it difficult to schedule the appropriate amounts of non-VRE generation ahead of time, especially for slow-start generators which cannot modify their real-time commitment (on/off) status. One way to address this issue is to over-schedule more than enough non-VRE generator capacity in the day-ahead to account for a range of VRE generation possibilities. However, this approach is very costly and inefficient.

Instead, in the current practice, grid operators resort to fast-start generators (e.g., combustion turbine plants) or VRE curtailment to reconcile the discrepancies between real-time demand and generation. Closing the resource gap in these ways increases the balancing operation costs, which are the cost differences between the day-ahead and real-time dispatches. However, becoming too reliant on fast-start generators (which are expensive) and VRE curtailment is also very costly and wasteful. Therefore, there are costs and risks associated with both overscheduling and under-scheduling the day-ahead generator capacities to meet net load demand in real-time.

As more VRE resources are installed and go online, grid operations will only become more complicated with greater net load variability. Consequences of suboptimal dispatch schedules can include increased energy costs and reduced grid reliability. There remains a need for a scheduling algorithm that can balance how much slow-start generation is scheduled in the day-ahead versus how much fast-start generation is utilized in real-time to address the net demand uncertainty. A need also remains for modifying current grid operations to schedule adequate ramp-feasible generator capacity in the day-ahead to follow the real-time net demand fluctuations cost-effectively.

### SUMMARY

In a first example, a computer-implemented method 500 for predicting a required committed capacity of an electric utility 100 includes performing a stochastic optimization 402 of raw data 304 to produce a total committed capacity from conventional thermal units as a target data. The raw data 304 includes grid operating conditions 306. The method 500 further includes combining the total committed capacity from conventional thermal units with raw features 304 and engineered features to generate training data. The method 500 further includes training a machine learning model 404 for predicting the required committed capacity of the electric utility 100 using the generated training data. The method 500 further includes predicting the required committed capacity of the electric utility 100 using the trained machine learning model 404. The method 500 further includes running an augmented version of a deterministic dispatch optimization model 406 based on the predicted required committed capacity of the electric utility 100.

In a second example, a non-transitory computer-readable medium 204 includes a required committed capacity (of the electric utility) control programming 302. Execution of the control programming 302 by one or more processors 202 configures one or more computing devices 116 to perform a stochastic optimization 402 of raw data 304 to produce a total committed capacity from conventional thermal units as a target data. The raw data 304 includes grid operating conditions 306. Execution of the control programming 302 by one or more processors 202 configures one or more computing devices 116 to combine the total committed capacity from conventional thermal units with raw features 304 and engineered features to generate training data. Execution of the control programming 302 by one or more processors 202 configures one or more computing devices 116 to train a machine learning model 404 for predicting the required committed capacity of the electric utility 100 using the generated training data. Execution of the control programming 302 by one or more processors 202 configures one or more computing devices 116 to predict the required committed capacity of the electric utility 100 using the trained machine learning model 404 for predicting the required committed capacity of the electric utility 100. Execution of the control programming 302 by one or more processors 202 configures one or more computing devices 116 to run an augmented version of a deterministic dispatch optimization model 406 based on the predicted required committed capacity of the electric utility 100.

In a third example, a computing device 116 includes a memory 204, a processor 202 coupled to the memory 204, and programming 302 in the memory 204. Execution of the programming 302 by the processor 202 configures the computing device 116 to perform a stochastic optimization 402 of raw data 304 to produce a total committed capacity from conventional thermal units as a target data. The raw data 304 includes grid operating conditions 306. Execution of the programming 302 by the processor 202 configures the computing device 116 to combine the total committed capacity from conventional thermal units with raw features 304 and engineered features to generate training data. Execution of the programming 302 by the processor 202 configures the computing device 116 to train a machine learning model 404 for predicting the required committed capacity of the electric utility 100 using the generated training data. Execution of the programming 302 by the processor 202 configures the computing device 116 to predict the required committed capacity of the electric utility 100 using the trained machine learning model 404. Execution of the programming 302 by the processor 202 configures the computing device 116 to run an augmented version of a deterministic dispatch optimization model 406 based on the predicted required committed capacity of the electric utility 100.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The drawing figures depict one or more implementations, by way of example only, not by way of limitations. In the figures, like reference numerals refer to the same or similar elements.

FIG. 1 depicts an example system for managing an energy system, according to embodiments of the present disclosure.

FIG. 2 is a schematic diagram of an example computing device, according to embodiments of the present disclosure, which can implement the methods of FIGS. 4-5.

FIG. 3 is a high-level functional block diagram of the system for managing an energy system of FIG. 1 that depicts components of the controller, the energy system, and the load and price forecasting system to predict the required committed capacity of the electric utility.

FIG. 4 is a flowchart depicting an augmented deterministic optimization, according to an embodiment.

FIG. 5 is a flowchart depicting an overall method for predicting a required committed capacity of an electric utility.

FIG. 6A illustrates plots of the capacity constraint performance for a minimum conventional capacity constraint, day-ahead (“DA”) scheduled conventional capacity with the stochastic approach, and DA scheduled conventional capacity with the augmented deterministic model.

FIG. 6B illustrates the optimized real-time power generation for the current practice (e.g., minimum conventional capacity constraint), the stochastic approach, and the augmented deterministic model.

### PARTS LISTING

100 Electric Utility
101 Energy Management System
102 Energy System
104 Renewable Power Generation System/Source
106 Non-Renewable Power Generation System/Source
108 Energy Storage System
110 Electrical Application
112 Controller
114 Load and Price Forecasting System(s)
116 User Computing Device
118 Network
202 Processor
204, 322 Memory
206 Network Communication Interface
208 Input Device
210 Output Device
302 Required Capacity Control Programming
304 Raw Data
306 Grid Operating Conditions
308 Solar or Wind Generation
310 Weather Forecast
312 Hourly Net Load Demand
314 Net Interchange Schedule
316 Region
318 Net Storage Schedule
320 Total Hourly Capacity of Slow-Start Units
324 Historical Storage State
326 Predicted Storage Control Programming
328 Total Hourly Capacity of Thermal Conventional Units
330 Machine Learning Model (“ML”) for Predicting Optimal Storage Behavior
400 Augmented Deterministic Optimization Approach
402 Stochastic Optimization
404 Machine Learning Model for Predicting Capacity
406 Augmented Deterministic Model
500 Method
602 Minimum Conventional Capacity Constraint
604 Day-ahead (“DA”) Scheduled Capacity with Stochastic Approach
606 DA Scheduled Capacity with Deterministic Model

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

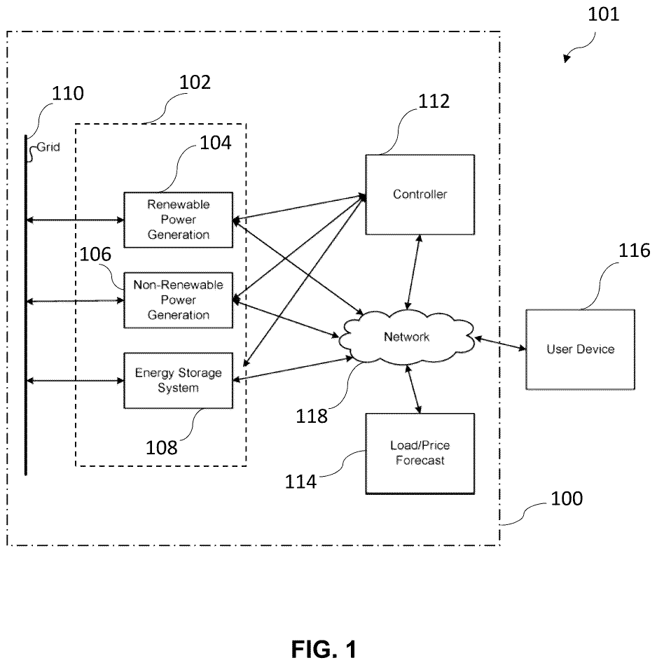

Unless otherwise indicated, any embodiment can be combined with any other embodiment. In particular, FIGS. 1-6 and the associated text are all combinable with each other.

The term “coupled” as used herein refers to any logical, physical, electrical, or optical connection, link or the like by which electricity, power, signals, or light produced or supplied by one system element are imparted to another coupled element. Unless described otherwise, coupled elements or devices are not necessarily directly connected to one another and may be separated by intermediate components, elements, or communication media that may modify, manipulate or carry the electricity, power, signals, or light.

Described herein is a method of using machine learning to predict critical constraints of utilities' generation assets to efficiently meet customer load and integrate the predicted critical constraints into a mathematical optimization model.

The method described herein can help utilities schedule their generation assets to meet their load, while minimizing operational costs. Traditionally, this could be accomplished by using a mathematical optimization algorithm that is deterministic in nature. Stochastic programming techniques produce better results than the deterministic algorithm, but at the cost of additional computational complexity and time. Although the market resonates with the more optimal results generated by the stochastic approach, the computational time is not ideal for some use cases.

The method described herein delivers results at a comparable level of speed and computational complexity as the deterministic-derived solutions. The method uses a unit commitment economic dispatch optimization (e.g., how utilities plan on scheduling their units to meet the demand of the power grid), which is traditionally accomplished by using a deterministic optimization. In particular, the deterministic approach uses a single set of future predictions (e.g., forecast) for load, future predictions for prices, and future predictions of renewable asset availability. The deterministic approach needs to have some prediction of future in order to schedule generation assets ahead of time.

The stochastic optimization is based on the same concept, but uses multiple different scenarios of the future predictions. In particular, the stochastic optimization does not optimize one single set of forecast, but optimizes over a set of load forecasts. This approach accounts for different ways the load might transpire over the next 24 hours, for example, by using past errors or the best information that is available.

The stochastic method is difficult to calculate and takes more time, but delivers better results than the deterministic method. The stochastic method can produce a range of forecasts, and if the future lies within that range, then the solution is better than the deterministic method that only considers a single forecast and the result falls very far from that forecast. However, decisions about the grid have to be made a day ahead of time; thus, there is limited time to solve a complex model of mathematical equations. The increase computational time makes the stochastic methods not suitable for predicting critical utilities' generation assets. For these reasons, the electric utilities industry currently uses primarily, if not solely, deterministic methods.

The method described herein combines the advantages of the stochastic methods and the deterministic methods. In particular, the method described herein is based on stochastic optimization and uses machine learning to learn generated capacity schedule, units to schedule, and how much capacity to take from each unit, considering the predicted future forecast. The method uses the generated capacity schedule, as predicted by the machine learning model that replicate the behavior of the stochastic optimization, as an input for the deterministic optimization model. In other words, the method described herein uses machine learning to bridge the gap between the stochastic and the deterministic optimization.

More specifically, the method described herein trains a machine learning model on carefully selected key constraints that influence reserve capacity decisions produced by the more-complex stochastic model.

The machine learning model then predicts the required committed capacity from conventional thermal power generation assets, such as nuclear, coal, and natural gas plants, for example that need to be started a day in advance of actual operation. Committed capacity in the context of the present description means that the capacity from conventional thermal power generation assets has been scheduled to turn on and generate electricity at a specific time at least a day in advance of actual operation of the from conventional thermal power generation assets so that the conventional thermal power generation assets have enough time to start and operate at the scheduled time. Committed capacity in the context of the present description is the committed capacity from slow-start thermal generators. The model uses the grid operating conditions (e.g., hourly net demand, net interchange, etc.) to form its prediction, and produces the total thermal capacity values at the desired time interval. This prediction is fed into a deterministic optimization algorithm as a capacity constraint, which helps produce high-quality results that are comparable to the stochastic approach, but at speeds similar to the speed of the deterministic approach.

The stochastic optimization can be performed once per month or once per week to obtain updated data for the machine learning model. Then, the machine learning model transfers that learning to the deterministic model that runs on a more frequent basis.

Reference now is made in detail to the examples illustrated in the accompanying drawings and discussed below.

FIG. 1 depicts an example system 101 for managing an energy system 102. The energy system 102 may include one or more renewable power generation systems 104, one or more non-renewable power generation systems 106, and/or one or more energy storage systems 108 that may deliver power to an electrical application 110 (e.g., a power consumer or grid). The system 101 may also include one or more controllers 112, one or more load and price forecasting systems 114, and/or one or more user devices 116 connected to each other via a network 118.

The network 118 may include one or more of any of various types of networks for communication of information, such as a cellular network (e.g., 2G, 3G, 4G, or 5G), a satellite network, a Wi-Fi network, a WiMAX network, a Bluetooth network, a near-field communication (NFC) network, a low-power wide-area networking (LPWAN) network, a mobile network, a terrestrial microwave network, a wireless ad hoc network, an Ethernet network, a telephone network, a power-line communication (PLC) network, a coaxial cable network, an optical fiber network, and/or the like. The network 118 may include a wired network or a wireless network. The network 118 may include a personal area network, a local area network, a metropolitan area network, a wide area network, a global area network, a space network, or any other type of computer network that may use data connections between network nodes. In some examples, the network 118 may include an Internet Protocol (IP) based network.

Renewable power generation systems 104 may include a renewable energy source, such as solar power and wind power, which can be intermittent and less reliable compared to fossil fuels.

Non-renewable power generation systems 106 may include a renewable energy source, such as oil, coal, natural gas, hydroelectric power generation systems, or other types of non-renewable power generation systems.

Energy storage 108 systems may include batteries or other devices capable of storing and discharging energy. To improve resiliency, energy storage system 108 can store energy from the energy system 102 when the production from the power source (e.g., 104, 106) is high. Later on, the energy storage system 108 can dispatch the energy to the electrical application 110 when demand is high or production from the power source (e.g., 104, 106) is not keeping up with demand. Moreover, events may occur when a connected load or an operating demand load of the electrical application 110 is excessive or there is electrical grid instability, such as during extreme weather. By storing energy from the power source (e.g., 104, 106) and then dispatching the energy during such events, the energy storage system 108 can continue to dispatch a required power flow of the electrical application 110.

Electrical application 110 can include an electrical grid, such as a power grid, or a smaller local load, such as a backup power system, for a facility such as a hospital, manufacturing site, residential home, or other suitable facility. The electrical application 110 may deliver AC or DC power for on-grid or off-grid applications, including commercial, industrial, or residential applications. The electrical application 110 may deliver power to buildings, electric vehicle charging stations, etc., including a variety of electrical loads that consume AC or DC electric power. The electrical application 110 can be a front-of-the-meter system that is owned or operated by a utility company or a behind-the-meter system that directly supplies buildings and homes with electricity.

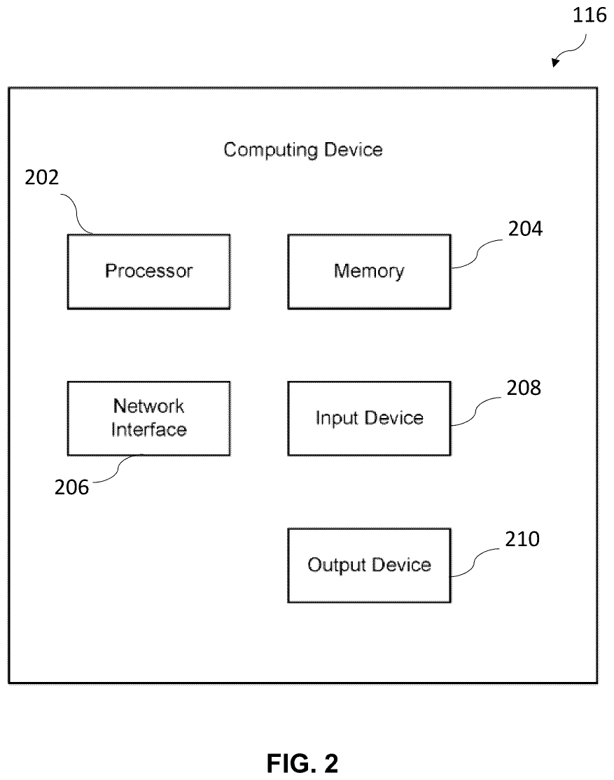

The user device 116 may include any type of computing device configured to perform one or more of the aspects described herein (e.g., for optimizing energy dispatch and/or for anomaly detection in energy storage systems). For example, the user device 116 may include at least one processor 202 and memory 204 (FIG. 2) storing instructions that, when executed by the at least one processor 202, cause the at least one processor 202 to perform one or more of the aspects described herein. The user device 116 may include, for example, a computer, a laptop computer, a desktop computer, a mainframe computer, a tablet, a smart phone, a mobile phone, a mobile device, a server device, a client device, an automotive electronics device, an extended reality headset, a smart watch, an Internet of things (IoT) device, or any other type of computing device. In some examples, the user device 116 may be configured to receive data from various sources (e.g., via the network 118), and/or to manage the energy system 102.

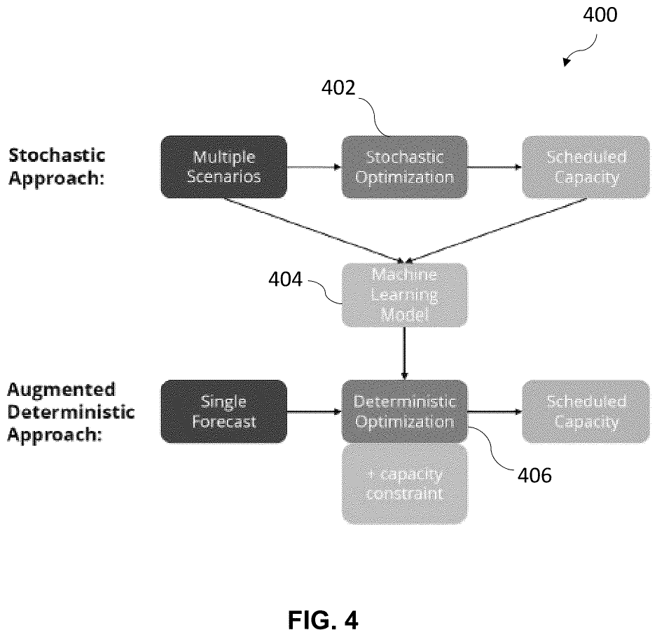

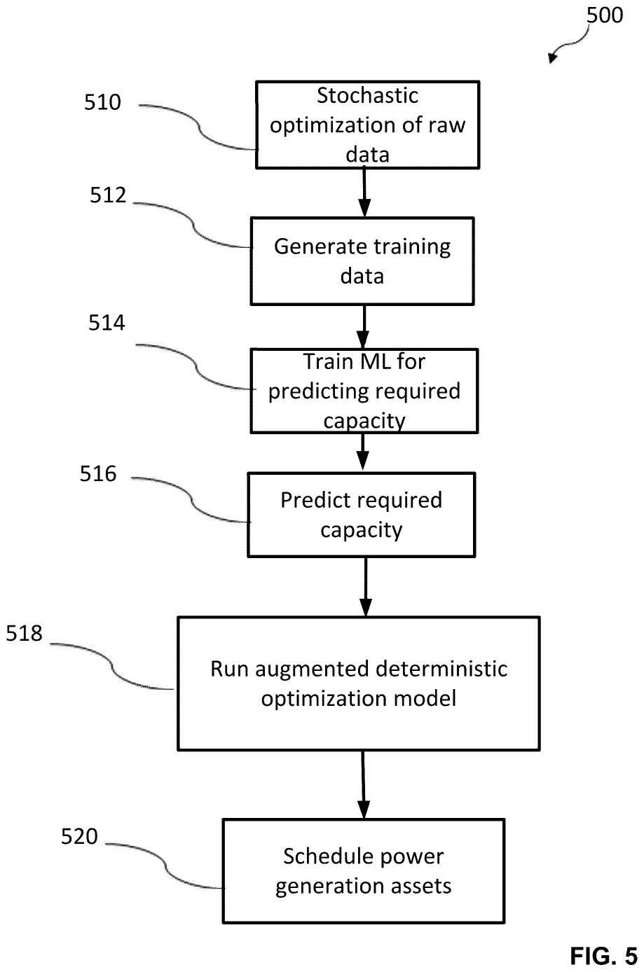

FIG. 2 shows an example computing device 116, consistent with some embodiments of the present disclosure, which can implement the methods 400, 500 of FIGS. 4-5. The computing device 116 may include, for example, at least one processor 202, at least one memory 204, at least one network communication interface 206, one or more input devices 208, and/or one or more output devices 210. The devices as described herein (e.g., the user device 116), the controller 112, and/or other computing devices may similarly include these components and/or may be implemented in a similar manner. In some examples, the computing device 116 of FIG. 2 including one or more of the above-described components may be implemented using virtualization technologies and/or cloud computing technologies.

The processor 202 may execute instructions of a computer program to perform any of the functions described herein. The processor 202 may include, for example, integrated circuits, microchips, microcontrollers, microprocessors, central processing units (CPUs), graphics processing units (GPUs), digital signal processors (DSPs), field programmable gate arrays (FPGAs), or other units suitable for executing instructions or performing logic operations. The processor 202 may include a single-core or multiple-core processor (e.g., dual-core, quad-core, or with any desired number of cores).

The memory 204 may include a non-transitory computer-readable medium that may store instructions that, when executed by at least one processor (e.g., processor 202), cause the at least one processor 202 to perform one or more processes as described herein.

The network communication interface 206 may include, for example, a network card, a modem, and/or the like, and may be configured to provide data communication (e.g., two-way data communication) with a network (e.g., the network). The network communication interface 206 may be a wireless communication interface, a wired communication interface, or a combination of the two.

The input device 208 may include, for example, a keyboard, a mouse, a touch pad, a touch screen, one or more buttons, a joystick, a microphone, and/or any other device configured to detect and/or receive input. In some examples, the input device 208 may include one or more of various types of sensors, such as an image sensor, a temperature sensor, a humidity sensor, a location sensor, or any other type of sensor.

The output device 210 may include, for example, a light indicator, a light source, a display (e.g., a light-emitting diode (LED) display, an organic light-emitting diode (OLED) display, a liquid-crystal display (LCD), or a dot-matrix display), a screen, a touch screen, a speaker, a headphone, a device configured to provide tactile cues, a vibrator, and/or any other device configured to provide output.

The memory 204 may store instructions that, when executed by at least one processor (e.g., processor 202), cause the at least one processor 202 to perform one or more processes as described herein. The instructions may include, for example, software instructions, computer programs, computer code, executable instructions, source code, machine instructions, machine language programs, or any other type of directions for a computing device. The instructions may be based on one or more of various types of desired programming languages, and may include (e.g., embody) various processes for optimizing energy dispatch and/or detecting anomaly in energy storage systems, as described herein.

In the context of the present description, the functions of the computer-implemented method 500 for predicting a required committed capacity of an electric utility may be carried out by a processor of the load and price forecasting system 114, the controller 112, and/or the user device 116. The program instructions of the method for predicting a required committed capacity of an electric utility may be stored in the memory of the load and price forecasting system 114, the controller 112, and/or the user device 116.

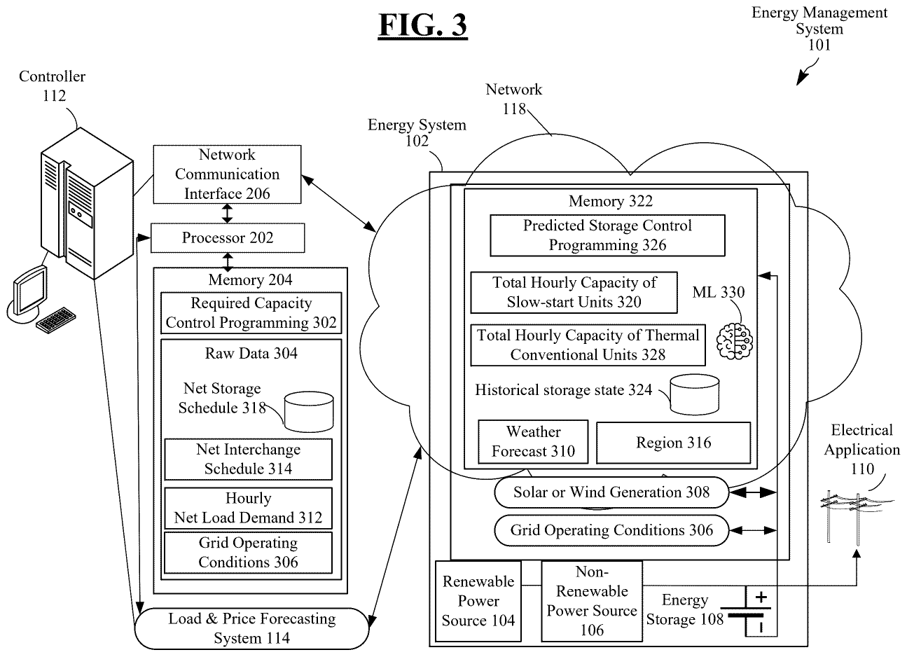

FIG. 3 is a high-level functional block diagram of the energy management system 101 of FIG. 1 that depicts components of the controller 112, the energy system 102, and the load and price forecasting system 114 connected to each other via a network 118 to predict the required committed capacity of the electric utility. As shown, the energy system 102 may include one or more renewable power generation source 104, one or more non-renewable power generation source 106, and/or one or more energy storage systems 108 that may deliver power to an electrical application 110 (e.g., a power consumer or grid), or a combination thereof.

The controller 112, energy storage nodes 105A-N, the energy system 102, the load and price forecasting system 114, the electrical application 103, and other components of the system 101 can be in communication over a network 118. The network 118 can be a local area network, wide area network, or a combination thereof. For example, the controller 112 can be coupled via network 118 to the load and price forecasting system 114, the power generation sources 104 and 106, the energy storage system 108, and the electrical application 110.

Controller 112 includes a network communication interface 206 configured for wired or wireless communication over the network 118. The controller 112 further includes a memory 204 and a processor 202 coupled to the network communication interface 206 and the memory 204. As shown, the memory 204 of the controller 112 is configured to store required capacity control programming 302 and raw data 304, such as grid operating conditions 306, hourly net load demand 312, and net interchange schedule 314.

Controller 112 is configured to receive from the energy system 102, and store in memory 204 or in a separate memory 322 of the energy system 102, additional raw data 304, such as solar or wind generation 308, weather forecast 310, region 316, net storage schedule 318, total capacity 320 of load-following slow-start units in every hour, and a historical observed state of storage 324, for example. The net storage schedule 318 can include an optimized schedule and a predicted schedule.

As further shown in FIG. 3, the memory 322 of the energy system 102 (or the memory 204 of the controller 112) can be configured to store a predicted storage control programming 326 and total capacity 328 of thermal conventional units for each hour, as scheduled in a day-ahead (“DA”) cycle.

The memory 322 of the energy system 102 (or the memory 204 of the controller 112) can further be configured to store a machine learning model (“ML”) 330 for predicting optimal storage behavior. The machine learning model 330 for predicting optimal storage behavior can be a separate module or part of the predicted storage control programming 326.

FIG. 4 is a flowchart depicting an augmented deterministic optimization approach 400 applied to a computer-implemented method for predicting a required committed capacity of an electric utility, according to an embodiment. The augmented deterministic optimization approach 400 illustrated in FIG. 4 combines the advantages of the stochastic approach and the deterministic approach by performing a stochastic optimization uses multiple scenarios of raw data 304 (such as future predictions of grid operating conditions 306, for example) to produce a total committed capacity from conventional thermal units, combines the total committed capacity from conventional thermal units with raw features 304 and engineered features to generate training data, and trains a machine learning model to predict the required committed capacity of the electric utility using the generated training data. The augmented deterministic optimization approach 400 uses the generated capacity schedule from the stochastic optimization as an input for an augmented version of a deterministic dispatch optimization model based on the predicted required committed capacity of the electric utility.

The augmented deterministic optimization approach 400 illustrated in FIG. 4 can include four separate models: stochastic optimization 402, a machine learning model for predicting optimal storage behavior 330 (shown in FIG. 3), a machine learning model 404 for predicting the required committed capacity of the electric utility, and an augmented deterministic model 406. Training the machine learning model 404 for predicting the required committed capacity of the electric utility does not require the storage prediction.

FIG. 5 is a flowchart depicting an overall method 500 for predicting a required committed capacity of an electric utility. The method 400 may be carried out by the controller 112. Alternatively, the method 500 may be carried out by a processor of the load and price forecasting system 114 and/or the user device 116.

At step 510 of method 500, the controller 112 performs a stochastic optimization of raw data 304 (e.g., initial input features) to produce a total committed capacity from conventional thermal units as a target data. The conventional thermal units can include nuclear, coal, or natural gas plants, combined cycle (“CC”) sources, combustion turbines (“CT”), or steam turbines (“ST”), for example.

The raw data 304 can include grid operating conditions 306 (FIG. 3).

In certain embodiments, as shown in FIG. 3, the raw data 304 can further include solar or wind generation 308, weather forecast 310, a plurality of sets of forecasts of hourly net load demand 312, a net interchange schedule 314, region 316, and a net storage schedule 318.

The net storage schedule 318 can include an optimized schedule and a predicted schedule.

In certain embodiments, as shown in FIG. 3, the raw data can 304 further include a total capacity 320 of load-following slow-start units in every hour, as scheduled by the stochastic optimization.

The initial input features can include hourly statistics of net load forecasts. Net load scenarios can be calculated from the load and solar forecasts used in the stochastic model by calculating, for each hour, the mean, min, max, range, variance, skew, and kurtosis of the load and solar forecasts.

The initial input features can include hourly average total load (MWh), hourly net interchange schedule used in the stochastic optimization (=exports−imports in MWh), and hourly DA net storage schedule resulting from the stochastic optimization. The net storage schedule=discharge−charge in MWh, averaged for each pump storage and battery unit across all scenarios and summed over all units for an hourly total.

Recognizing the variability in net demand from one year to the next, the method 500 is not limited to one year's worth of training data. To increase the amount of training data, the method 500 can artificially generate four additional sets of load scenarios by randomly increasing or decreasing the load in each hour within a given range, thereby randomly altering the net load. The engineered new features lead to a better prediction of the conventional capacity. Generation of artificial data can also be used to model the demand and renewable generation growth in future years. Alternatively, instead of artificially generating additional data, the method 500 can use historical data.

At step 512 of method 500, the controller 112 combines the total committed capacity from conventional thermal units with raw features 304 and engineered features to generate training data.

At step 514 of method 500, the controller 112 trains a machine learning model for predicting the required committed capacity of the electric utility using the generated training data.

The training of the machine learning model can include Neural Nets (pytorch), Random Forests (sklearn), Gradient Boosting (Light GBM & XGBoost).

The training of the machine learning model for predicting the required committed capacity of the electric utility can include the step of engineering additional input features from the raw data 304.

From the initial set of inputs (e.g., the raw data 304), the controller 112 can automatically generate a large list of over 300 engineered features. Examples of the 300 or more engineered features may include raising variables to different powers (e.g., x², x³, etc.), different ratio combinations (e.g., x2/x3, x2/x4, etc.), different lagged values (e.g., x at t−5 to predict y at t, x at t−4 to predict y at t, etc.), and different variable transformations (e.g., log (x)).

The training of the machine learning model for predicting the required committed capacity of the electric utility can include the step of selecting a subset of features from the additional input features and the raw data 304.

The 300 or more engineered features may be reduced to ˜80 features by removing low information, highly null, and single-value features, as well as highly correlated features (e.g., the FeatureTools package includes functions for all four of these reductions). From the remaining ˜80 features, the method 400 selects the top 10 features that have the highest mutual information score with the target data (e.g., as calculated by sklearn) for training.

The target data can include total capacity of thermal conventional units for each hour (e.g., hourly committed capacity), as scheduled by the stochastic optimization in a day-ahead (“DA”) cycle. The hourly committed capacity is the sum of the scenario-independent DA capacity for nuclear, coal, CC, CT, and ST units. This calculation excludes hydro, solar, pump-storage hydro, and battery storage units.

Mutual information captures nonlinear dependency between an input feature and the target variable.

The selected subset of features (e.g., the final input features, which are all hourly) can include mean net demand, lagged mean net demand (e.g., t−1 to t−5), mean net demand/mean total demand, month of year (e.g., integer), Is_weekday (e.g., binary indicating whether the day of the week is a week day, as opposed to weekend), net storage schedule (=discharge−charge), and net interchange schedule (=exports−imports).

The step of selecting the subset of features can include measuring the dependency between each feature and a target variable representing a total conventional capacity scheduled by the stochastic optimization, equaling to zero if two random variables are independent, capturing non-linear dependencies, removing low-information features, reducing highly correlated features, Lasso regression, Ridge regression, and selecting top features that have a highest mutual information score with the target data.

The stochastic optimization (step 510 in FIG. 5) is used occasionally to generate training data for the machine learning model for predicting the required committed capacity of the electric utility. The stochastic optimization is only used when new training data is needed in production.

At step 516 of method 500, the controller 112 predicts the required committed capacity of the electric utility using the trained machine learning model for predicting the required committed capacity of the electric utility.

The machine learning model for predicting the required committed capacity of the electric utility is used daily to generate the generation capacity constraint on conventional thermal sources for the augmented deterministic dispatch optimization model.

At step 518 of method 500, the controller 112 runs an augmented version of a deterministic dispatch optimization model based on the predicted required committed capacity of the electric utility. In particular, the controller 112 uses the generated predicted required committed capacity schedule from the stochastic optimization (steps 510-516) as an input for the augmented version of the deterministic dispatch optimization model.

Generally, the deterministic model may be a mixed-integer linear optimization model (“MILP”) of a unit commitment/economic dispatch problem that seeks to minimize the cost of committing and dispatching electricity generation units given a set of constraints on resources (e.g., generation system, storage, demand response, resource mix, transmission system, etc.) to ensure reliability and economic efficiency. All future forecasts may be taken as a certainty, and the deterministic model optimizes the generation over a set of certain future forecasts of load, solar availability, prices, etc. These forecasts may be single-point estimates for each hour that are assumed to be realized with 100% probability.

The augmented deterministic model is similar to the deterministic model, but with an added generation capacity constraint on conventional thermal sources, including but not limited to, combined cycle (“CC”) sources, combustion turbines (“CT”), and/or steam turbines (“ST”), for example. The added generation capacity constraint allows the deterministic model to intelligently mimic the behavior of the stochastic optimization. This constraint may be added as a way to transfer the uncertain information (e.g., net load uncertainty) that the stochastic optimization is privy to back to a deterministic model without the need to use uncertain future forecasts (i.e., scenarios), similar to the stochastic model, based on the predicted total conventional capacity, rather than CC capacity because conventional capacity in aggregate is directly responsive to net load.

The predicted required committed capacity of the electric utility is used to augment the conventional deterministic dispatch optimization model by running the deterministic dispatch optimization model using the capacity prediction as a minimum constraint on the conventional capacity in a day-ahead (“DA”) cycle.

Equations (1a)-(1j) below represent the deterministic unit commitment (“UC”) formulation. The augmented deterministic model minimizes the total cost of satisfying net electricity demand (demand−scheduled VRE production) while abiding generators' operational limits and market clearing constraints.

$$min TC = {\sum }_{t = 1}^{{N}^{T}} [ {\sum }_{g = 1}^{{N}_{G}} ( {C}_{gt}^{SU} {V}_{gt}^{DA} + {P}_{gt}^{DA} {O}_{gt}^{DA} ) ] + {dev}_{t} \times penalty \qquad ( 1 a )$$

$${P}_{gt}^{DA} + {UR}_{gt}^{DA} \leq {\overline{P}}_{g} {U}_{gt}^{DA} ∀ g , ∀ t \qquad ( 1 b )$$

$${\underline{P}}_{g} {U}_{gt}^{DA} \leq {P}_{gt}^{DA} - {DR}_{gt}^{DA} ∀ g , ∀ t \qquad ( 1 c )$$

$${P}_{gt}^{DA} - {P}_{g , t - 1}^{DA} \leq {ρ}_{g}^{o} {U}_{g , t - 1}^{DA} + {ρ}_{g}^{SU} {V}_{gt}^{DA} ∀ g , ∀ t \qquad ( 1 d )$$

$${P}_{g , t - 1}^{DA} - {P}_{gt}^{DA} \leq {ρ}_{g}^{o} {U}_{gt}^{DA} + {ρ}_{g}^{SD} {Y}_{gt}^{DA} ∀ g , ∀ t \qquad ( 1 e )$$

$${U}_{g , t - 1}^{DA} - {U}_{gt}^{DA} + {V}_{gt}^{DA} - {Y}_{gt}^{DA} = 0 ∀ g , ∀ t \qquad ( 1 f )$$

$$0 \leq {W}_{t}^{DA} \leq {\overline{W}}_{t}^{DA} ∀ t \qquad ( 1 g )$$

$${\sum }_{g = 1}^{NG} {P}_{gt}^{DA} + {W}_{t}^{DA} - {D}_{t} = 0 ∀ t \qquad ( 1 h )$$

$$( {U}^{DA} , {V}^{DA} , {Y}^{DA} ) ∈ {Ψ}^{o} \qquad ( 1 i )$$

$$( {\sum }_{cg = 1}^{NCC} {\overline{P}}_{cg} {U}_{cgt}^{DA} ) + {dev}_{t} \geq {SP}_{t} ∀ cg , ∀ t \qquad ( 1 j )$$

The “augmented” component of the deterministic model is captured in equation (1j), which enforces a minimum total capacity constraint on conventional thermal units. Equation (1j) ensures that total capacity from conventional thermal units scheduled in the day-ahead (“DA”) amounts to what a stochastic DA-UC would schedule (or a prediction of what a stochastic DA-UC would schedule) from these units given the uncertainty in forecasted net demand. The inclusion of the minimum total capacity constraint ensures that enough flexible capacity is scheduled with online generators to hedge against the uncertainty in VRE generation and net demand. In other words, the scheduled online capacity provides sufficient capacity to supply the expected consumption, as well as the up and down reserves required to manage deviations of actual net demand, from the day-ahead forecasts in the most cost-effective manner. This constraint also allows for the augmented deterministic model to violate the minimum capacity requirement when it is reasonably cost-effective to do so. For example, a slack variable, devₜ, represents the deviation from the minimum capacity requirement, and the penalty cost, penalty, values the associated per MW cost of not meeting the requirement. The total cost of violating the constraint (devₜ×penalty) is included in the objective function. Violations are allowed to ensure the model meets the requirement in the most cost-effective manner. For instance, if the scheduled capacity is 1 MW short of meeting the minimum threshold, then scheduling the additional 1 MW (which necessitates starting up another generator) can be impractical. The violation provides flexibility for the model to avoid additional startup costs simply to meet the capacity threshold specified in the constraint.

The added generation capacity constraint can be a machine learning (“ML”)-informed capacity constraint. In particular, the method 500 can include training a machine learning model for predicting storage schedule by using a historical observed state of storage. The storage schedule is a key input for predicting capacity, and the capacity prediction model is trained with the actual storage schedule from the stochastic optimization. However, to predict capacity in practice, the storage schedule input cannot come from stochastic optimization, due to the computational constraints of the stochastic optimization model. Therefore, the method 500 uses a second machine learning model to predict storage charge and discharge behavior.

The predicted storage is used as an input feature for the machine learning model for predicting the required committed capacity of the electric utility. The machine learning model for predicting optimal storage behavior generates a storage schedule for test data by training the machine learning model for predicting the required of the electric utility to predict storage charge and discharge behavior.

The machine learning model for predicting optimal storage behavior is trained daily to generate a prediction of storage behavior. The predicted storage behavior is used as an input feature to the machine learning model for predicting the required committed capacity of the electric utility.

The augmented version of the deterministic dispatch optimization model is performed daily to produce a unit commitment and a dispatch plan for a customer, by using the predicted required committed capacity of the electric utility as an input. In particular, the augmented version of the deterministic optimization model outputs an optimized storage schedule and the stochastic optimization uses the optimized storage schedule as an input feature.

The machine learning model for predicting the required committed capacity of the electric utility is occasionally improved by re-training the machine learning model for predicting the required committed capacity of the electric utility with updated data.

The machine learning model for predicting the required committed capacity of the electric utility can predict total thermal capacity values at a predetermined time interval. The total thermal capacity values can include the capacity of thermal power generation assets, such as nuclear, coal, or natural gas plants, combined cycle (“CC”) sources, combustion turbines (“CT”), or steam turbines (“ST”), for example.

The machine learning model for predicting the required committed capacity of the electric utility uses the grid operating conditions to predict the total thermal capacity values at the predetermined time interval. The grid operating conditions can include hourly net demand and net interchange,” for example.

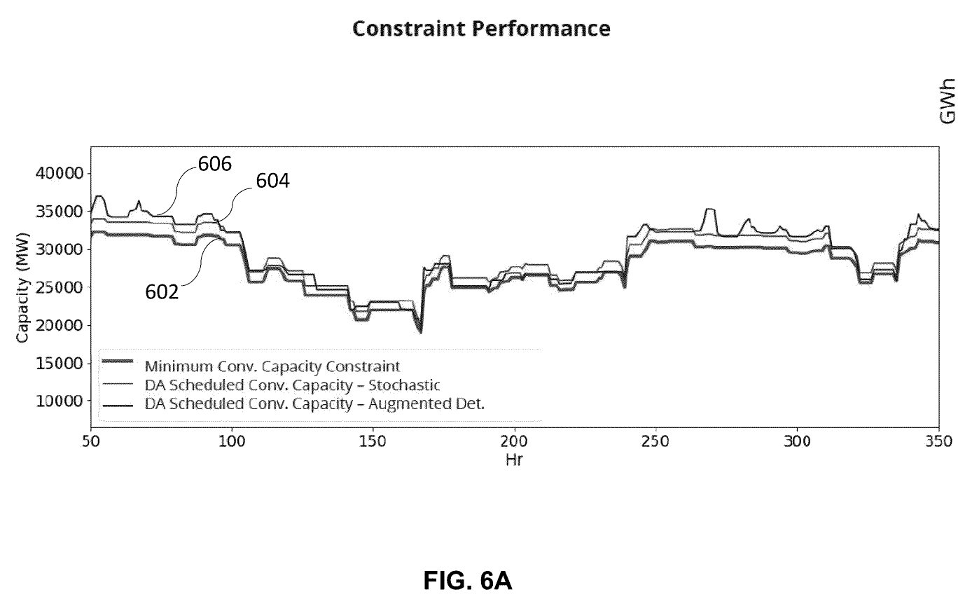

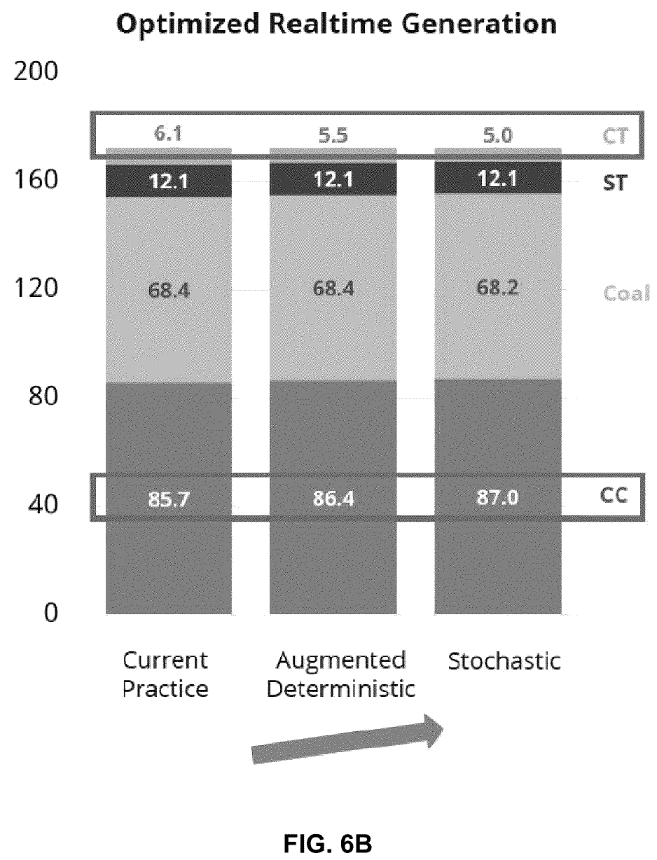

FIG. 6A illustrates plots of the capacity constraint performance for a minimum conventional capacity constraint 602, day-ahead (“DA”) scheduled conventional capacity with the stochastic approach 604, and DA scheduled conventional capacity with the augmented deterministic model 606.

FIG. 6B illustrates the optimized real-time power generation for the current practice (e.g., minimum conventional capacity constraint), the stochastic approach, and the augmented deterministic model. Adding a capacity constraint to the deterministic model achieves the desired effect: The augmented deterministic model results in a lower cost unit commitment and dispatch solutions than the original deterministic model in a fraction of the time a stochastic model takes to solve. The augmented deterministic model decreases cost by −0.7%, relative to a normal deterministic model for the current generation mix case. This trend holds for a future generation mix case with increased solar and storage.

The stochastic model may also be a mixed-integer linear optimization model (“MILP”), similar to the deterministic model, that seeks to minimize the cost of committing and dispatching electricity generation units given a set of constraints. However, the difference here is that the future forecasts are uncertain, and the stochastic optimization may handle this uncertainty though using a set of future scenarios (e.g., multiple scenarios), instead of a single forecast estimate for each hour, for load, solar availability, prices, etc. Each scenario may be a different realization with its own associated probability, and the sum of probabilities across all scenarios is equal to 100%. Although both the deterministic and the stochastic models are MILPs, the stochastic optimization is much more difficult to solve because of the increased model complexity (curse of dimensionality) and is computationally expensive to do so. But because the stochastic optimization considers a range of possible future outcomes versus a single future outcome, its results are better (i.e., lower generation cost) than the deterministic model since the actual outcome has a greater chance of lying within a range of outcomes versus matching closely to a single outcome. These advantages of the stochastic optimization provided the present inventors with the motivation to develop a method that mimics the stochastic optimization behavior in a deterministic setting to obtain similar results, but much more quickly in terms of computational time.

MILP optimization problems may be solved using solvers like CPLEX, Gurobi, Mosek, Xpress, or other types of solvers. The present disclosure is not dependent on how one skilled in the art of computation technologies ultimately chooses to solve a MILP.

An optimized storage schedule may be an output of the stochastic model. The augmented deterministic model may use a predicted storage schedule as an input. The predicted storage schedule may closely approximate the optimized storage schedule from the stochastic model. The storage schedule may be predicted using a gradient boost model that minimizes the Mean Square Error (“MSE”). Similar to the stochastic model, the augmented deterministic model may also output an optimized storage schedule.

Mean square error is defined below, where Y (i) is the prediction and Y\hat{ }(i) is the actual value the method is trying to predict. This is a commonly used metric used to capture a model's accuracy.

$$MSE = \frac{1}{n} {\sum }_{i = 1}^{n} {( {Y}_{i} - {\hat{Y}}_{i} )}^{2} .$$

In one embodiment, scenario data from PGscen (a publicly available tool to support research on stochastic optimization by teams funded by the DOE ARPA-E program) may be used to generated the day-ahead load and solar scenarios. At a high level, all scenario generation methods aim to learn the uncertainty information in the historical forecasts and then create future scenarios using a model that characterizes this uncertainty. The ML method to predict critical constraints is independent of the scenario generation method. The ML method only requires a set of scenarios as input. Additionally, or alternatively, an in-house developed scenario generation method may be used.

Some generator settings may include one or more of minimum up time, minimum down time, ramp up rate, ramp down rate, startup costs, variable operating and maintenance costs, minimum generation capacity, and heat requirements.

The method 500 can further include a step of testing the machine learning model for predicting the required committed capacity of the electric utility by generating storage schedule for test data, training the machine learning model for predicting the required committed capacity of the electric utility with the test data, predicting the required committed capacity of the electric utility using the trained machine learning model for predicting the required committed capacity of the electric utility with the test data, and using the predicted required committed capacity to augment the deterministic dispatch optimization model.

Turning back to FIG. 5, at step 520 of method 500, the controller 112 schedules power generation assets, turning on and off of electric generators, and generating of power, by the electric utility, based on the predicted required committed capacity of the electric utility.

The method described herein combines the advantages of the stochastic methods and the deterministic methods by applying a machine learning model on the predicted total committed capacity from conventional thermal units calculated with a stochastic optimization to predict the required committed capacity of the electric utility, and use the predicted required committed capacity of the electric utility as an input for an augmented version of a deterministic dispatch optimization model. The method described herein applies machine learning to bridge the gap between the stochastic and the deterministic optimization and produce high-quality results that are comparable to the stochastic approach, but at speeds similar to the speed of the deterministic approach.

It will be understood that the operational steps of method 500 are performed by the computers or processors described herein upon loading and executing software code or instructions which are tangibly stored on a tangible, non-transitory computer readable storage medium, such as on a magnetic medium, e.g., a computer hard drive, an optical medium, e.g., an optical disc, solid-state memory, e.g., flash memory, or other storage media known in the art. Thus, any of the functionality performed by the computers or processors described herein described herein is implemented in software code or instructions which are tangibly stored on a tangible, non-transitory computer readable storage medium. Upon loading and executing such software code or instructions by the computers or processors, the computers or processors may perform any of the functionality of the computers or processors described herein, including any steps of the methods described herein.

The term “software code” or “code” used herein refers to any instructions or set of instructions that influence the operation of computers or processors. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

In the examples above, the energy management system 101, energy system 102, energy application 110, the load and price forecasting system 114, controller 112, etc. each include a network communication interface 206 for wired or wireless communication over one or more networks 118. The network 118 may support data communication by equipment at the premises via wired (e.g. cable or fiber) media or via wireless (e.g. Wi-Fi, Bluetooth™, ZigBee, LiFi, IrDA, etc.) or combinations of wired and wireless technology. The specific design and implementation of the network communication interface 206 may depend on the communication network via which the computing device 116 is intended to operate. For example, the network communication interface 206 may include a Wireless Local Area Network (WLAN) card, an Integrated Services Digital Network (ISDN) card, a cellular modem, a satellite modem, a modem configured to provide data communication connections via the Internet, a network card with an Ethernet port, a device with radio frequency receivers and transmitters, a device with optical receivers and transmitters, and/or the like. In some examples, the network communication interface 206 may be designed to operate via the network 118. The network communication interface 206 may be configured to send and receive electrical, electromagnetic, or optical signals that may represent various types of data.

Any of the functionality of the computer-implemented method 500 for predicting a required committed capacity of an electric utility, including required capacity control programming 302 and predicted storage control programming 326, described herein for the energy management system 101, energy system 102, electrical application 110, the load and price forecasting system 114, controller 112, etc. can be embodied in one more applications or firmware as described previously. According to some embodiments, “function,” “functions,” “application,” “applications,” “instruction,” “instructions,” or “programming” are program(s) that execute functions defined in the programs. Various programming languages can be employed to create one or more of the applications, structured in a variety of manners, such as object-oriented programming languages (e.g., Objective-C, Java, or C++) or procedural programming languages (e.g., C or assembly language).

In the examples above, the energy management system 101, energy system 102, electrical application 110, the load and price forecasting system 114, controller 112, etc., can each include a processor. As used herein, a processor 202 is a hardware circuit having elements structured and arranged to perform one or more processing functions, typically various data processing functions. The processor 202 may provide the ability to execute, control, run, or store multiple processes, applications, or programs. In some examples, the processor 202 may be configured to provide parallel processing functionalities to allow a device associated with the processor 202 to execute multiple processes simultaneously. In some examples, the processor 202 may be configured with virtualization technologies. Other types of processor arrangements may be implemented to provide the capabilities described herein.

The memory 204 may include a non-transitory computer-readable medium that may store instructions that, when executed by at least one processor (e.g., processor 202), cause the at least one processor 202 to perform one or more processes as described herein. A non-transitory computer-readable medium may include any type of physical memory on which information or data readable by at least one processor may be stored. A non-transitory computer-readable medium may include, for example, random access memory (RAM), read-only memory (ROM), compact disc read-only memory (CD-ROM), digital versatile discs (DVDs), programmable read-only memory (PROM), erasable programmable read-only memory (EPROM), non-volatile random-access memory (NVRAM), volatile memory, non-volatile memory, hard drives, flash drives, disks, caches, registers, an optical data storage medium, a physical medium with patterns, or networked versions thereof. A non-transitory computer-readable medium may include multiple structures and may be located at a local location or at a remote location.

The memory 204 may include a flash memory (non-volatile or persistent storage), a read-only memory (ROM), and a random access memory (RAM) (volatile storage). The RAM serves as short term storage for instructions and data being handled by the processor 202, e.g., as a working data processing memory. The flash memory typically provides longer term storage.

Of course, other storage devices or configurations may be added to or substituted for those in the example. Such other storage devices may be implemented using any type of storage medium having computer or processor readable instructions or programming stored therein and may include, for example, any or all of the tangible memory of the computers, processors or the like, or associated modules.

Hence, a machine-readable medium or a computer-readable medium may take many forms of tangible storage medium. Non-volatile storage media include, for example, optical or magnetic disks, such as any of the storage devices in any computer(s) or the like, such as may be used to implement the client device, media gateway, transcoder, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

According to exemplary embodiments of the present disclosure the one or more processors and control circuits can include one or more of any known general purpose processor or integrated circuit such as a central processing unit (CPU), microprocessor, field programmable gate array (FPGA), Application Specific Integrated Circuit (ASIC), Digital Signal Processor (DSP), or other suitable programmable processing or computing device or circuit as desired that is specially programmed to perform operations for achieving the results of the exemplar embodiments described herein. The processor(s) can be configured to include and perform features of the exemplary embodiments of the present disclosure, such as the computer-implemented method 400 for predicting a required committed capacity of an electric utility. The features can be performed through program code encoded or recorded on the processor(s), or stored in a non-volatile memory device, such as Read-Only Memory (ROM), erasable programmable read-only memory (EPROM), or other suitable memory device or circuit as desired. Accordingly, such computer programs can represent controllers of the computing device.

In another exemplary embodiment, the program code, such as the computer-implemented method 400 for predicting a required committed capacity of an electric utility, can be provided in a computer program product having a non-transitory computer readable medium, such as Magnetic Storage Media (e.g. hard disks, floppy discs, or magnetic tape), optical media (e.g., any type of compact disc (CD), or any type of digital video disc (DVD), or other compatible non-volatile memory device as desired) and downloaded to the processor(s) for execution as desired, when the non-transitory computer readable medium is placed in communicable contact with the processor(s).

The one or more processors 202 can be included in a computing system that is configured with components such as memory, a hard drive, an input/output (I/O) interface, a communication interface, a display and any other suitable component as desired. The exemplary computing device 116 can also include a communications interface 206. The communications interface 206 can be configured to allow software and data to be transferred between the computing device 116 and external devices. Exemplary communications interfaces can include a modem, a network interface (e.g., an Ethernet card), a communications port, a PCMCIA slot and card, or any other suitable network communication interface as desired. Software and data transferred via the communications interface 206 can be in the form of signals, which can be electronic, electromagnetic, optical, or other signals as will be apparent to persons having skill in the relevant art. The signals can travel via a communications path, which can be configured to carry the signals and can be implemented using wire, cable, fiber optics, a phone line, a cellular phone link, a radio frequency link, or any other suitable communication link as desired.

Where the present disclosure is implemented using programming or software, including the computer-implemented method 400 for predicting a required committed capacity of an electric utility, the programming or software can be stored in a computer program product or non-transitory computer readable medium and loaded into the computing device using a removable storage drive or communications interface. In an exemplary embodiment, any computing device, such as controller 112, disclosed herein can also include a display interface that outputs display signals to a display unit, e.g., LCD screen, plasma screen, LED screen, DLP screen, CRT screen, or any other suitable graphical interface as desired.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” “has,” “having,” “containing,” “contain”, “contains,” “with,” “formed of,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element. Unless otherwise stated, the articles “a” or “an” preceding an element mean one or more of the elements.

Unless otherwise stated, any and all measurements, values, ratings, positions, magnitudes, sizes, angles, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±5% or as much as ±10% from the stated amount. The terms “approximately” and “substantially” mean that the parameter value or the like varies up to ±10% from the stated amount.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

1. A computer-implemented method for predicting a required committed capacity of an electric utility, said method comprising:
(a) performing a stochastic optimization of raw data to produce a total committed capacity from conventional thermal units as a target data, wherein the raw data comprises grid operating conditions;
(b) combining the total committed capacity from conventional thermal units with raw features and engineered features to generate training data;
(c) training a machine learning model for predicting the required committed capacity of the electric utility using the generated training data;
(d) predicting the required committed capacity of the electric utility using the trained machine learning model for predicting the required committed capacity of the electric utility; and
(e) running an augmented version of a deterministic dispatch optimization model based on the predicted required committed capacity of the electric utility.

2. The computer-implemented method of claim 1, wherein the raw data further comprises solar or wind generation, weather forecast, a plurality of sets of forecasts of hourly net load demand, a net interchange schedule, region, a net storage schedule, and a total capacity of load-following slow-start units in every hour, as scheduled by the stochastic optimization, wherein the net storage schedule comprises an optimized schedule and a predicted schedule.

3. (canceled)

4. (canceled)

5. The computer-implemented method of claim 1, wherein the training the machine learning model for predicting the required committed capacity of the electric utility comprises engineering additional input features from the raw data and selecting a subset of features from the additional input features and the raw data, wherein the subset of features comprises mean net demand, lagged mean net demand, mean net demand/mean total demand, month of year, Is weekday, net storage schedule, and net interchange schedule.

6. (canceled)

7. The computer-implemented method of claim 5, wherein the selecting the subset of features comprises measuring a dependency between each feature and a target variable representing a total conventional capacity scheduled by the stochastic optimization, equaling to zero if two random variables are independent, capturing non-linear dependencies, removing low-information features, reducing highly correlated features, Lasso regression, Ridge regression, and selecting top features that have a highest mutual information score with the target data.

8. (canceled)

9. The computer-implemented method of claim 1, further comprising training a machine learning model for predicting optimal storage behavior by using a historical observed state of storage, wherein the predicted optimal storage behavior is used as an input feature for the machine learning model for predicting the required committed capacity of the electric utility.

10. (canceled)

11. The computer-implemented method of claim 9, wherein the machine learning model for predicting optimal storage behavior generates a storage schedule for test data by training the machine learning model for predicting the required committed capacity of the electric utility to predict storage charge and discharge behavior.

12. The computer-implemented method of claim 9, wherein the machine learning model for predicting optimal storage behavior is trained daily to generate a prediction of storage behavior, said prediction of storage behavior being used as an input feature to the machine learning model for predicting the required committed capacity of the electric utility.

13. The computer-implemented method of claim 1, wherein the machine learning model for predicting the required committed capacity of the electric utility is used daily to generate a capacity constraint for the augmented deterministic dispatch optimization model that is improved by re-training the machine learning model for predicting the required committed capacity of the electric utility with updated data.

14. The computer-implemented method of claim 1, further comprising testing the machine learning model for predicting the required committed capacity of the electric utility by generating storage schedule for test data, training the machine learning model for predicting the required committed capacity of the electric utility with the test data, predicting the required committed capacity of the electric utility using the trained machine learning model for predicting the required committed capacity of the electric utility with the test data, and using the predicted required committed capacity to augment the deterministic dispatch optimization model.

15. The computer-implemented method of claim 14, wherein the predicted required committed capacity is used to augment the deterministic dispatch optimization model by running the deterministic dispatch optimization model using the capacity prediction as a minimum constraint on a conventional capacity in a day-ahead (“DA”) cycle.

16. The computer-implemented method of claim 1, wherein the predicting the capacity of the electric utility predicts total thermal committed capacity values at a predetermined time interval, wherein the total thermal capacity values comprise the committed capacity of thermal power generation assets.

17. (canceled)

18. The computer-implemented method of claim 16, wherein the thermal power generation assets comprise nuclear, coal, or natural gas plants, combined cycle (“CC”) sources, combustion turbines (“CT”), or steam turbines (“ST”).

19. The computer-implemented method of claim 16, wherein the predicting the required committed capacity of the electric utility uses the grid operating conditions to predict the total thermal committed capacity values at the predetermined time interval.

20. The computer-implemented method of claim 1, wherein the grid operating conditions comprise hourly net demand and net interchange.

21. The computer-implemented method of claim 1, wherein the target data comprises total committed capacity of thermal conventional units for each hour, as scheduled by the stochastic optimization in a day-ahead (“DA”) cycle.

22. The computer-implemented method of claim 1, wherein the augmented version of the deterministic dispatch optimization model is performed daily to produce a unit commitment and a dispatch plan for a customer, said augmented version of the deterministic dispatch optimization model using the predicted required committed capacity of the electric utility as an input.

23. The computer-implemented method of claim 22, wherein the augmented version of the deterministic optimization model outputs an optimized storage schedule and the stochastic optimization uses the optimized storage schedule as an input feature.

24. The computer-implemented method of claim 1, further comprising scheduling power generation assets, turning on and off of electric generators, and generating power, by the electric utility, based on the predicted required committed capacity of the electric utility.

25. A non-transitory computer-readable medium, comprising programming, wherein execution of the programming by a processor configures a computing device to:
(a) perform a stochastic optimization of raw data to produce a total committed capacity from conventional thermal units as a target data, wherein the raw data comprises grid operating conditions;
(b) combine the total committed capacity from conventional thermal units with raw features and engineered features to generate training data;
(c) train a machine learning model for predicting the required committed capacity of the electric utility using the generated training data;
(d) predict the required committed capacity of the electric utility using the trained machine learning model; and
(e) run an augmented version of a deterministic dispatch optimization model based on the predicted required committed capacity of the electric utility.

26. A computing device, comprising:
a memory;
a processor coupled to the memory; and
programming in the memory, wherein execution of the programming by the processor configures the computing device to:
(a) perform a stochastic optimization of raw data to produce a total committed capacity from conventional thermal units as a target data, wherein the raw data comprises grid operating conditions;
(b) combine the total committed capacity from conventional thermal units with raw features and engineered features to generate training data;
(c) train a machine learning model for predicting the required committed capacity of the electric utility using the generated training data;
(d) predict the required committed capacity of the electric utility using the trained machine learning model; and
(e) run an augmented version of a deterministic dispatch optimization model based on the predicted required committed capacity of the electric utility.
